(19) United States
(12) Patent Application Publication
(10) Pub. No.: US 2024/0181817 A1
(43) Pub. Date: Jun. 6, 2024

(54) PNEUMATIC TIRE

(71) Applicant: BRIDGESTONE CORPORATION, Chuo-ku, Tokyo (JP)

(72) Inventors: Takashi OSAKA, Chuo-ku, Tokyo (JP); Keiichi TAKAMURA, Chuo-ku, Tokyo (JP)

(73) Assignee: BRIDGESTONE CORPORATION, Chuo-ku, Tokyo (JP)

(21) Appl. No.: 18/259,278

(22) PCT Filed: Oct. 28, 2021
(86) PCT No.: PCT/JP2021/039894

§ 371 Date: Jun. 26, 2023

(30) Foreign Application Priority Data
Jun. 30, 2021 (JP) 2021-109745

(51) Int. Cl. B60C 19/00

(52) U.S. Cl. CPC B60C 19/00

(57) ABSTRACT

A pneumatic tire of this disclosure includes a plurality of communication devices disposed on a sidewall portion, one or more of the plurality of communication devices are disposed on one tire width direction half portion bounded by a tire equatorial plane, and one or more of the plurality of communication devices are disposed on the other tire width direction half portion bounded by the tire equatorial plane, and the plurality of communication devices are disposed to be separated from one another by 45° or more in a tire circumferential direction when a position of a tire central axis is central, in a side view of the tire.

### TECHNICAL FIELD

This disclosure relates to a pneumatic tire.

### BACKGROUND

There has been conventionally known a pneumatic tire including a communication device such as a Radio Frequency (RF) tag having a memory or the like to read and write data of manufacturing management, delivery management, usage history management, etc. of the tire (for example, see PTL 1).

### CITATION LIST

### Patent Literature

PTL 1: JP2017531825A

### SUMMARY

### Technical Problem

The tire as described above may be unable to read and write the information on the tire as described above when the communication device is separated from the tire or when the communication device breaks down.

It could be helpful to provide a pneumatic tire that prevents information on the tire from being unable to be read and written.

### Solution to Problem

We provide:
(1) a pneumatic tire comprising a plurality of communication devices disposed on a sidewall portion, wherein
   one or more of the plurality of communication devices are disposed on one tire width direction half portion bounded by a tire equatorial plane, and one or more of the plurality of communication devices are disposed on the other tire width direction half portion bounded by the tire equatorial plane, and
   the plurality of communication devices are disposed to be separated from one another by 45° or more in a tire circumferential direction when a position of a tire central axis is central, in a side view of the tire.

### Advantageous Effect

This disclosure can provide a pneumatic tire that prevents information on the tire from being unable to be read and written.

### BRIEF DESCRIPTION OF THE DRAWINGS

In the accompanying drawings:

FIG. 1 is a schematic tire width direction cross-sectional view of a pneumatic tire according to one of the disclosed embodiments;

FIG. 2 is a schematic view illustrating one example of the configuration of a communication device;

FIG. 3 is a schematic front view of the pneumatic tire according to one of the embodiments; and

FIG. 4 is a schematic side view of the pneumatic tire according to one of the embodiments.

### DETAILED DESCRIPTION

Hereinafter, embodiments of the present disclosure will be illustratively described in detail with reference to the drawings.

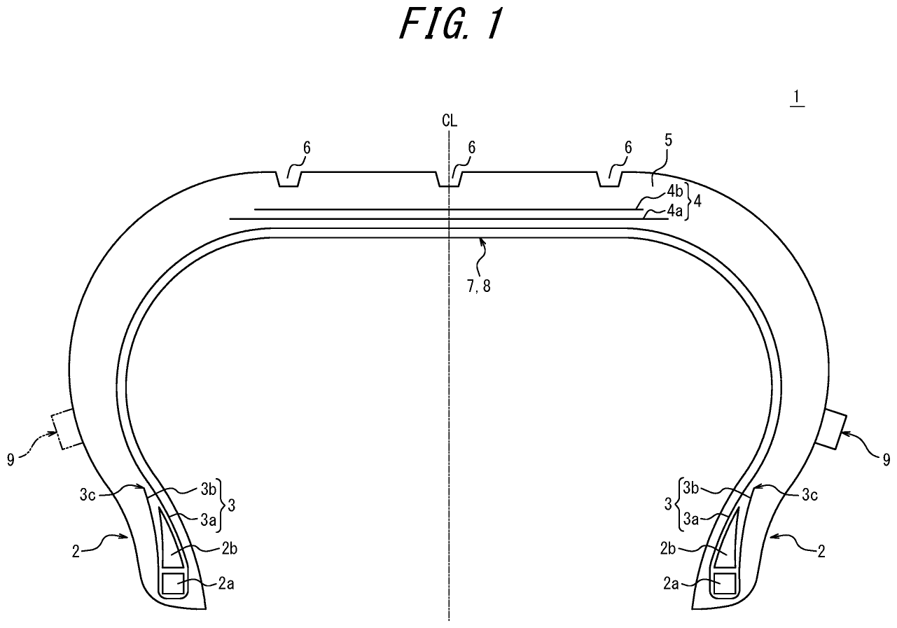

FIG. 1 is a tire width direction cross-sectional view of a pneumatic tire according to one of the disclosed embodiments. As illustrated in FIG. 1, this tire 1 includes: a pair of bead portions 2; a carcass 3 toroidally extending between the pair of bead portions 2; a belt 4 formed by one or more belt layers disposed outward in the tire radial direction of a crown portion of the carcass 3; and a tread 5 disposed outward in the tire radial direction of the belt 4.

In the illustrated example, a bead core 2a is embedded in the bead portion 2, and a bead filler 2b having a substantially triangular cross section is disposed outward in the tire radial direction of the bead core 2a.

In the illustrated example, the carcass 3 is composed of one or more carcass plies. The carcass 3 includes a carcass main body 3a toroidally extending between the pair of bead portions 2, and a carcass turn-up portion 3b that continues from the carcass main body 3a and turns up around the bead core 2a. In the illustrated example, the end of the carcass turn-up portion 3b terminates outward in the tire radial direction with respect to the outward end in the tire radial direction of the bead filler 2b, but the position of the end of the carcass turn-up portion 3b is not limited to this. The cord of the carcass ply is not particularly limited but may be an organic fiber cord.

In the illustrated example, the belt 4 includes two belt layers 4a and 4b and is an inclined belt in which belt cords extend so as to intersect one another between the layers. The angle with respect to the tire circumferential direction of belt cord is not particularly limited but may be, for example, 15° to 60°. The number of layers of the belt layer is not particularly limited so long as there are one or more layers. The material of the belt cord is not particularly limited, and a steel cord may be used.

In the illustrated example, the tread 5 is formed of a single-layer tread rubber but may be formed as a tread having a multi-layer rubber in the tire radial direction or the tire width direction. In the illustrated example, three circumferential main grooves 6 are provided on the tread 5, but the number of the circumferential main grooves, the groove width, the groove depth, the groove shape, etc. are not particularly limited.

In the illustrated example, an inner liner 8 is disposed on a tire inner surface 7. This can prevent the permeation of air and gas.

As illustrated in FIG. 1, this tire 1 includes a plurality of communication devices 9 disposed on a sidewall portion. In this example, the plurality of communication devices 9 are disposed with shifted one another in the tire circumferential direction as described below. Only one communication device 9 is present and illustrated with a solid line at the cross section of FIG. 1. A communication device 9 that is present at another cross section is also illustrated with a dashed line.

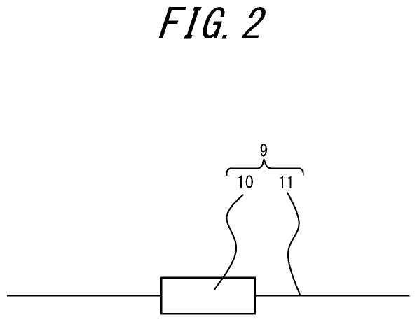

FIG. 2 is a schematic view illustrating one example of the configuration of the communication device. The communication device 9 performs wireless communication. In the illustrated example, the communication device 9 is an RF tag having: one or more (two in the illustrated example) antennas 11 that transmit and/or receive an electromagnetic wave; and an IC chip 10 that has a storage.

In this example, the IC chip 10 has any known memory, the storage and any known processor, a controller. The antenna 11 is connected to the IC chip 10 and extends linearly, wavily, or helicoidally. In this example, two antennas 11 are extending in opposite directions one another. The IC chip 10 may be operated by a dielectric electromotive force generated by the electromagnetic wave received by the one or more antennas 11. That is, the communication device 9 may be a passive communication device. Alternatively, the communication device 9 may further include a battery to allow communication by generating an electromagnetic wave with its own electric power. That is, the communication device 9 may be an active communication device. The communication device 9 can read data of manufacturing management, delivery management, usage history management, etc. of the tire, which has been stored in the storage, or write such data in the storage.

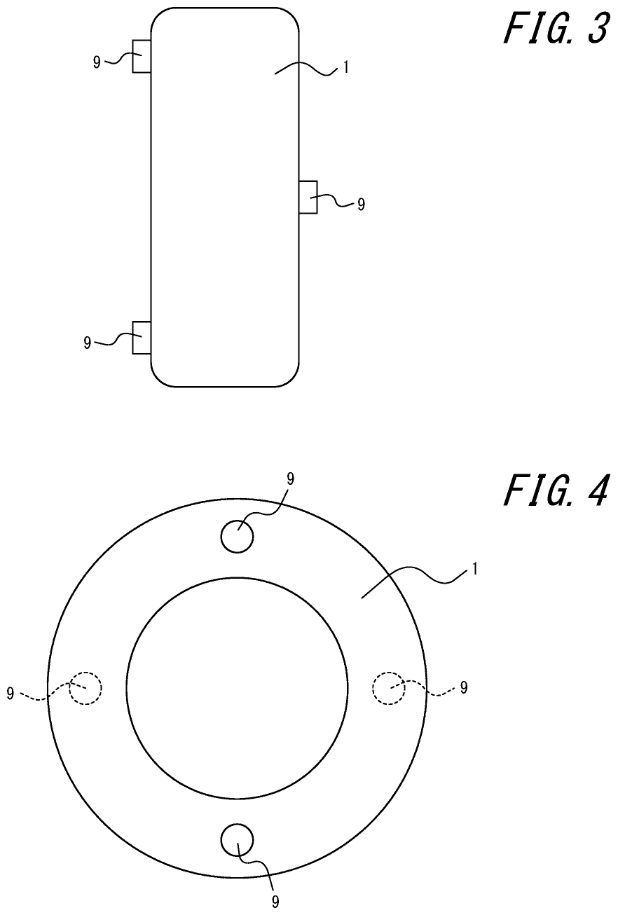

FIG. 3 is a schematic front view of the pneumatic tire according to one of the embodiments. FIG. 4 is a schematic side view of the pneumatic tire according to one of the embodiments. As illustrated in FIG. 3 and FIG. 4, one or more (two in the illustrated example) of the plurality of communication devices 9 are disposed on one tire width direction half portion bounded by a tire equatorial plane CL, and one or more (two in the illustrated example) of the plurality of communication devices 9 are disposed on the other tire width direction half portion bounded by the tire equatorial plane CL. In FIG. 4, the communication devices 9 disposed on one half portion (near side in the drawing) are illustrated with solid lines, while the communication devices 9 disposed on the other half portion (far side in the drawing) are illustrated with dashed lines.

The plurality of communication devices 9 (two communication devices 9 adjacent to one another in the tire circumferential direction) are disposed to be separated from one another by 45° or more (90° at regular intervals in the illustrated example) in the tire circumferential direction when the position of a tire central axis is central, in a side view of the tire, as illustrated in FIG. 4.

Hereinafter, operations and effects of the pneumatic tire of the present embodiment will be described.

In the pneumatic tire of this embodiment, one or more (two in the illustrated example) of the plurality of communication devices 9 are disposed on one tire width direction half portion bounded by the tire equatorial plane CL, and one or more (two in the illustrated example) of the plurality of communication devices 9 are disposed on the other tire width direction half portion bounded by the tire equatorial plane CL. Therefore, for example, even when an event that causes the breakdown or separation of the communication device 9 (e.g., a foreign object flying in and hitting the tire) occurs at any tire width direction half portion and the breakdown or separation of the communication device 9 actually occurs, if the communication device 9 at the other half portion is not affected, the communication device 9 at the other half portion can read and write information on the tire.

The plurality of communication devices 9 are disposed to be separated from one another by 45° or more (90° at regular intervals in the illustrated example) in the tire circumferential direction when the position of the tire central axis is central, in a side view of the tire. Therefore, for example, even when an event that causes the breakdown or separation of the communication device 9 (e.g. deformation due to grounding, or the tire hitting a foreign object) occurs when the tire is rolling, and the breakdown or separation of the communication device 9 actually occurs, this event that causes the breakdown or separation may not occur or the degree of this event may be decreased at the communication device 9 separated by 45° or more in the tire circumferential direction for the reason of, for example, the difference in timing of grounding. Accordingly, the communication device 9 whose position is different by 45° or more in the tire circumferential direction can read and write information on the tire.

As described above, according to the present embodiment, it is possible to prevent information on the tire from being unable to be read and written.

The plurality of communication devices are preferably disposed at regular intervals in the tire circumferential direction. It is because such disposition can equalize the influence of the event that causes the breakdown or separation of the communication device when the tire is rolling, such as deformation including deflection due to grounding, to further ensure any of the communication devices be left with fulfilling the function.

In the disposition at regular intervals in the tire circumferential direction, it does not matter at which tire width direction half portion the communication devices are positioned. Therefore, for example, FIG. 4 illustrates an example in which four communication devices are disposed at regular intervals by 90° in the tire circumferential direction.

The plurality of communication devices 9 (two communication devices 9 adjacent to one another in the tire circumferential direction) do not necessarily have to be disposed at regular intervals in the tire circumferential direction as long as the plurality of communication devices 9 are separated from one another by 45° or more in the tire circumferential direction when the position of the tire central axis is central, in a side view of the tire.

As illustrated in FIG. 3 and FIG. 4, the communication devices disposed on one tire width direction half portion and the communication devices disposed on the other tire width direction half portion are preferably alternately arranged in the tire circumferential direction. It is because when an event that causes the breakdown or the like occurs at one communication device, another communication device adjacent to the one communication device in the tire circumferential direction will be positioned at the tire width direction half portion different from the tire width direction half portion at which the one communication device is positioned, and this can avoid as much as possible the influence of the event that causes the breakdown or the like on the other communication device.

However, the tire of this disclosure is not limited to this case, and the communication devices may be disposed on one tire width direction half portion and the other tire width direction half portion one by one.

The tire 1 preferably includes even number of the communication devices. It is because equalizing the number of the communication devices disposed on one tire width direction half portion and the number of the communication devices disposed on the other tire width direction half portion can further equalize the influence of the event that causes the breakdown. However, the tire 1 may include odd number of communication devices.

In this embodiment, the communication device 9 is attached to the surface of the sidewall portion of the tire 1. In this example, the communication device 9 is attached to the surface of the sidewall portion via an adhesion layer (not illustrated). Any known adhesive can be used for the adhesion layer. As another example, the communication device 9 may be embedded in the sidewall portion.

In this example, the communication device 9 is positioned outward in the tire radial direction with respect to the end of the carcass turn-up portion 3b but is positioned inward in the tire radial direction with respect to a tire maximum width portion (part where the tire width in the tire width direction is maximum in a cross sectional view of FIG. 1). This can cause the carcass to reduce inhibition of transmitting and receiving of the electromagnetic wave and can increase durability of the communication device by avoiding a part near a buttress portion where deformation is large. On the other hand, the disposition of the communication device 9 is not limited to this example. The communication device 9 may be positioned inward in the tire radial direction with respect to the end of the carcass turn-up portion 3b. The communication device 9 may be positioned outward in the tire radial direction with respect to the tire maximum width portion.

Although no specific limitations are placed on the pneumatic tire of this disclosure, the pneumatic tire of this disclosure is particularly suitable for a passenger vehicle tire or a tire for truck and bus.

### REFERENCE SIGNS LIST

1 tire
2 bead portion
3 carcass
4 belt
5 tread
6 circumferential main groove
7 tire inner surface
8 inner liner
9 communication device
10 IC chip
11 antenna

1. A pneumatic tire comprising a plurality of communication devices disposed on a sidewall portion, wherein
one or more of the plurality of communication devices are disposed on one tire width direction half portion bounded by a tire equatorial plane, and one or more of the plurality of communication devices are disposed on the other tire width direction half portion bounded by the tire equatorial plane, and
the plurality of communication devices are disposed to be separated from one another by 45° or more in a tire circumferential direction when a position of a tire central axis is central, in a side view of the tire.

2. The pneumatic tire according to claim 1, wherein the plurality of communication devices are disposed at regular intervals in the tire circumferential direction.

3. The pneumatic tire according to claim 1, wherein the communication devices disposed on the one half portion and the communication devices disposed on the other half portion are alternately arranged in the tire circumferential direction.

4. The pneumatic tire according to claim 1, comprising even number of the communication devices.

5. The pneumatic tire according to claim 2, wherein the communication devices disposed on the one half portion and the communication devices disposed on the other half portion are alternately arranged in the tire circumferential direction.

6. The pneumatic tire according to claim 2, comprising even number of the communication devices.

7. The pneumatic tire according to claim 3, comprising even number of the communication devices.

8. The pneumatic tire according to claim 5, comprising even number of the communication devices.
